(19) United States
(12) Patent Application Publication
(10) Pub. No.: US 2013/0326568 A1
(43) Pub. Date: Dec. 5, 2013

(54) MOVIE-SCREENING MANAGEMENT DEVICE AND MOVIE-SCREENING MANAGEMENT METHOD

(71) Applicant: Sony Corporation, Tokyo (JP)

(72) Inventors: Toshiaki TANAKA, Kanagawa (JP); Hidenori FUKUDA, Kanagawa (JP)

(21) Appl. No.: 13/899,761

(22) Filed: May 22, 2013

(30) Foreign Application Priority Data
May 29, 2012 (JP) 2012-121447

(51) Int. Cl. H04N 21/214

(52) U.S. Cl. CPC H04N 21/214
USPC 725/82

(57) ABSTRACT

A movie-screening management device includes: a mutual-state monitoring unit monitoring mutual states by periodically performing communication with other parties connected through a network to exchange information when being logged; a content/playlist synchronization management unit sharing contents and playlists with the other parties; and a key management unit comprehensively managing keys necessary for reproducing the contents with respect to the other parties.

### FIELD

The present disclosure relates to a movie-screening management device and a movie-screening management method. Particularly, the present disclosure relates to a movie-screening management device and a movie-screening management method suitable to be installed in a small-scale cinema complex having a small number of screens.

### BACKGROUND

A movie theater called a cinema complex in which plural screens are provided in the same facility is increasing. Each screen includes a projector and a media server managing the projector. All media servers are connected to a theater management system (TMS) and the entire movie theater is comprehensively managed by the theater management system. A digital-cinema system generally operates in a so-called master-worker system, in which one theater management system manages plural media servers to perform operation of contents or playlists (for example, refer to JP-A-2003-244625 (Patent Document 1)).

### SUMMARY

Though the theater management system is extremely useful in operation of movie theaters having a large number of screens, in small-scale movie theaters, for example, having two or three screens, installation of the expensive theater management system will be a burden. For example, in small-scale movie theaters seen in emerging nations and so on in which development is anticipated in the future, the heavy burden of initial installation costs will be obstructive to the installation.

In view of the above, it is desirable to provide a movie-screening management device and a movie-screening management method capable of realizing reduction of installation costs by allowing media servers included in respective projectors to have functions which have been taken by the theater management system.

An embodiment of the present disclosure is directed to a movie-screening management device including a mutual-state monitoring unit monitoring mutual states by periodically performing communication with other parties connected through a network to exchange information when being logged, a content/playlist synchronization management unit sharing contents and playlists with the other parties, and a key management unit comprehensively managing keys necessary for reproducing the contents with respect to the other parties.

Another embodiment of the present disclosure is directed to a movie-screening management method including acquiring information of a table of playlists and a table of contents possessed by other parties by periodically performing communication with other parties connected through a network when being logged, when instructed to edit or reproduce a playlist in the acquired table of playlists, acquiring a copy of the playlist from the other party having the playlist, and when instructed to reproduce a playlist in the acquired table of playlists, acquiring contents included in the playlist from the other party having the playlist in the background and reproducing the contents by using keys mounted on a hot folder.

According to the embodiments of the present disclosure, information necessary for movie screening is shared with other parties to be connected, therefore, comprehensive management can be realized even in a small-scale movie theater in which installation of a theater management system is not necessary, which may obtain effects of staff reduction and so on.

### BRIEF DESCRIPTION OF THE DRAWINGS

FIG. 1 is a diagram showing a system configuration example of a small-scale movie theater to which a movie-screening management device according to an embodiment of the present disclosure is applied;

FIG. 2 is a schematic diagram for explaining a function of a mutual-state monitoring unit;

FIG. 3 is a diagram showing an operation sequence the mutual-state monitoring unit;

FIG. 4 is a schematic diagram indicating the sharing of contents/playlists in a content/playlist synchronization management unit;

FIG. 5 is a view showing an example of a screen for sharing contents/playlists not having detailed information;

FIG. 6 is a view showing an example of a screen for sharing contents/playlists indicated during acquisition of detailed information;

FIG. 7 is a view showing an example of a screen for sharing contents/playlists obtained after the detailed information is acquired;

FIG. 8 is a diagram showing an operation sequence of the content/playlist synchronization management unit;

FIG. 9 is a diagram for explaining the sharing of keys in a key management unit;

FIG. 10 is a chart showing a configuration example of an abstract instruction conversion table used by an automation management unit; and

FIG. 11 is a diagram showing a configuration example of hardware of a media server.

### DETAILED DESCRIPTION

Hereinafter, an embodiment of the present disclosure will be explained in detail with reference to the drawings by citing a case in which a movie-screening management device is applied to a media server for managing a projector as an example.

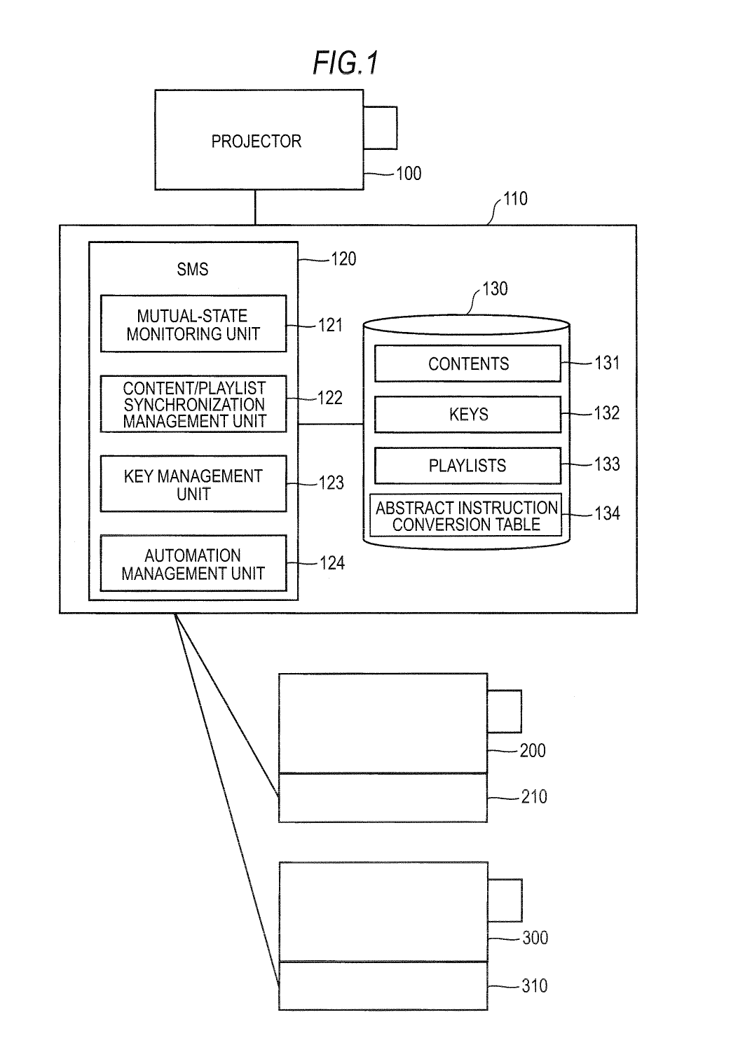

FIG. 1 is a diagram showing a system configuration example of a small-scale movie theater to which the movie-screening management device according to the embodiment of the present disclosure is applied.

As an example of the small-scale movie theater, a case of a cinema complex having three screens in which three projectors 100, 200 and 300 are installed will be explained here. Respective projectors 100, 200 and 300 include media servers 110, 210 and 310.

As the media servers 110, 210 and 310 respectively include functions of a theater management system, the media server 110 will be explained here as representative of media servers. The media server 110 includes a screen management system (SMS) 120 and a storage unit 130. The screen management system 120 includes a mutual-state monitoring unit 121, a content/playlist synchronization management unit 122, a key management unit 123 and an automation management unit 124.

The mutual-state monitoring unit 121 checks mutual operating states by periodically performing communication with screen management systems of other media servers 210 and 310 to exchange information. Accordingly, as the screen management system 120 is peer-to-peer connected to the screen management systems of other media servers 210 and 310, the screen management system being logged, as a master, periodically monitors mutual states with respect to the screen management systems of other parties.

The content/playlist synchronization management unit 122 manages synchronization of contents and playlists thereof to share contents and playlists with other media servers 210 and 310. The synchronization of contents is performed in the background as the transfer of a file having a large amount of data takes time. The playlists include composition playlists (CPLs) associating files of video, audio, subtitles and so on of contents to be shown, and show playlists (SPLs) prescribing the order of contents to be shown.

The key management unit 123 comprehensively manages KDMs (key Delivery Messages) in which decryption keys of encrypted contents are encrypted to share the keys so that the contents can be reproduced in any screen in the cinema complex.

The automation management unit 124 uniformly manages automation operations among screen management systems, which include the setting of an audio processor, the control of brightness of illumination, the control of curtains for changing the size of a movie-showing screen and so on performed in respective screens.

The storage unit 130 includes contents 131, keys 132, playlists 133 and an abstract instruction conversion table 134. The contents 131 are digital cinema packages (DCPs) distributed to respective movie theaters by being delivered through satellites and networks or by being stored in storage such as a hard disk. The keys 132 store KDMs for releasing the encrypted digital cinema packages. In particular, the KDMs are mounted on a hot folder for managing keys in the storage unit 130. The playlists 133 store the composition playlists, the show playlists and playlists of automation operation. The abstract instruction conversion table 134 stores a correspondence table between abstract instructions and conversion instructions of automation.

Next, respective functions of the mutual-state monitoring unit 121, the content/playlist synchronization management unit 122, the key management unit 123 and the automation management unit 124 included in the screen management system 120 will be sequentially explained.

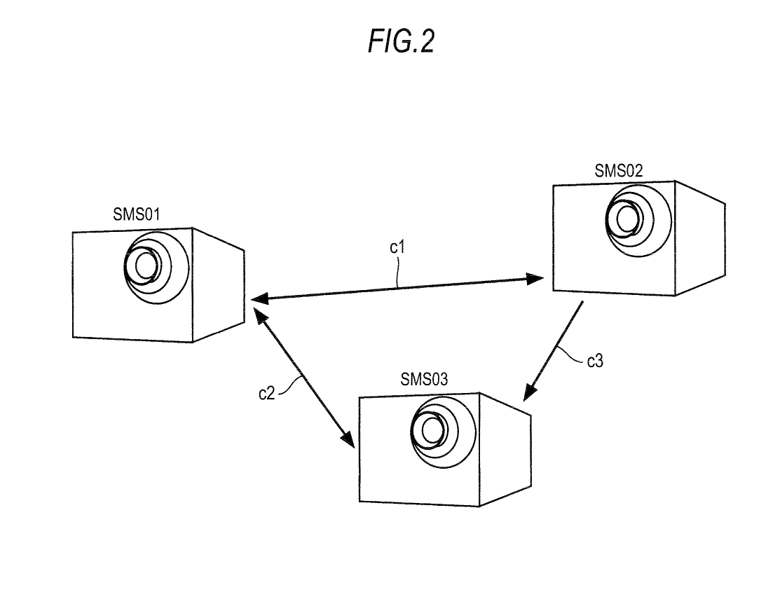

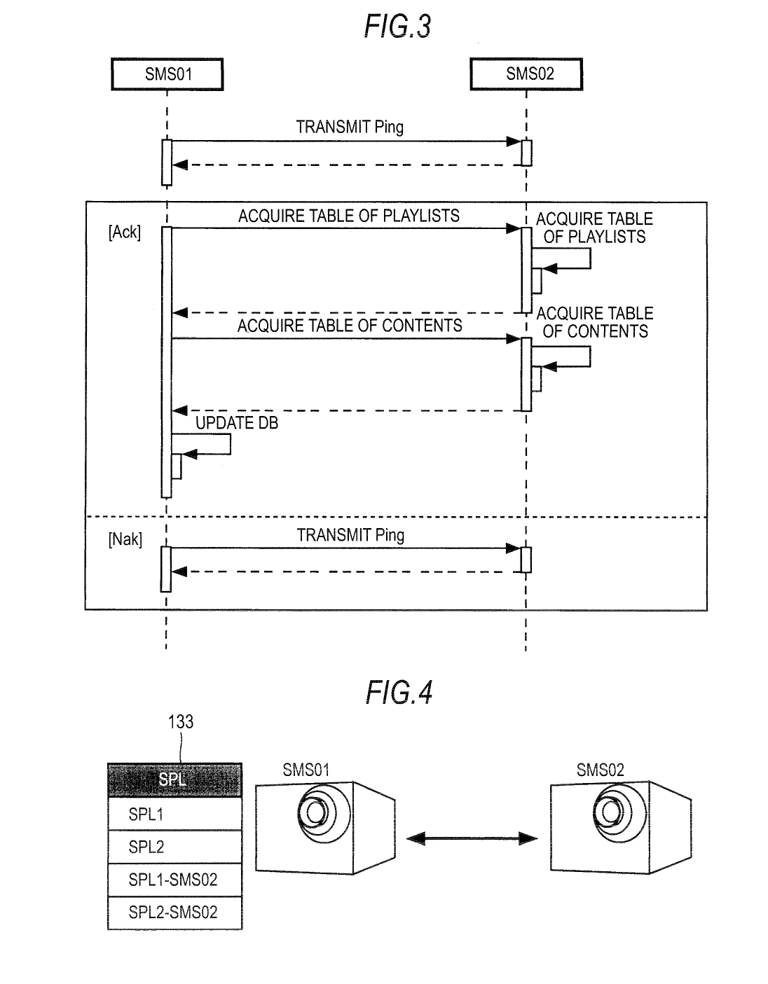

FIG. 2 is a schematic diagram for explaining a function of the mutual-state monitoring unit and FIG. 3 is a diagram showing an operation sequence the mutual state monitoring unit. In FIG. 2 and FIG. 3, the screen management system to which the user logs-in in the screen management systems of the media servers 110, 210 and 310 is represented as a SMS01. Screen management systems which are peer-to-peer connected to the screen management system SMS01 are represented as SMS02 and SMS03.

In the screen management system SMS01 being logged, the mutual-state monitoring unit 121 periodically performs communications c1 and c2 with the screen management system SMS02 or with the screen management system SMS03 as shown in FIG. 2 to collect information and monitor states. Here, as the number of hops in the screen management system SMS01 is only “1”, the screen management system SMS01 does not concern a communication c3 between the screen management system SMS02 and the screen management system SMS03.

At this time, states to be monitored are states of the screen management systems SMS02 and SMS03, which are, for example, “a state where communication disconnection occurs and the system is not connected to a network”, “the power is off”, “during reproduction and it is difficult to perform high-load work” and so on.

Information such as playlists is collected and updated during the communication. Note that only the screen management system SMS01 which performs operations has a network configuration. This is for prevent the network configuration from being complicated and further, this is because the network configuration managed by the screen management screen may be dynamically changed.

Next, as the operation sequence of the mutual-state monitoring unit 121, when the user logs in to the screen management system SMS01 as shown in FIG. 3, the screen management system SMS01 reads a setting file storing the network configuration from a storage area of the system itself. In the setting file, IP addresses are linked with names of screen management systems.

The screen management system SMS01 transmits a Ping command for checking network connectivity to respective screen management systems (a case of the screen management system SMS02 is shown in the drawing) from the read setting file.

Here, when an acknowledgement Ack is returned in response to the Ping command, it is determined that the network to the target screen management system is normal and that the target screen management system normally operates.

When the acknowledgement Ack is returned, the screen management system SMS01 requests the target screen management system SMS02 to acquire a table of playlists. The screen management system SMS02 which has received the request acquires data of the table of playlists from a storage area of the system itself and transmits the data to the screen management system SMS01. Similarly, the screen management system SMS01 requests the screen management system SMS02 to acquire a table of content lists. The screen management system SMS02 which has received the request acquires data of the table of content lists from the storage area of the system itself and transmits the data to the screen management system SMS01. Then, the screen management system SMS01 updates a database concerning the able of playlists and the table of content lists of the system itself by the acquired data of the table of playlists and the table of content lists, and ends the processing at this time. The screen management system SMS01 subsequently performs the same processing to the screen management system SMS03.

On the other hand, when the response to the Ping is not returned from the screen management system indicated by the read setting file, the screen management system SMS01 determines that “the network is disconnected” or “the power is off”. In this case, as it is difficult to acquire tables of playlists and content lists, the screen management system SMS01 does not acquire the tables of playlists and content lists.

The processing of the Ping by the screen management system SMS01 is repeatedly performed at regular time intervals so that the latest state of all screen management systems indicated by the setting file can be constantly obtained. Accordingly, for example, information such as a state where a new content has been added to a certain screen management system and a state where a media server the power of which was off has been recovered can be constantly obtained. Therefore, for example, when the user requests the access to the table of playlists, the screen management system SMS01 allows the user to access the table of playlists in the latest data immediately.

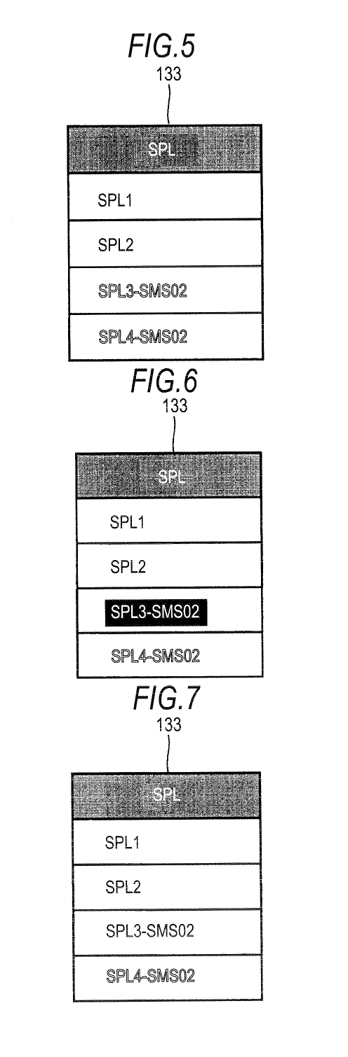

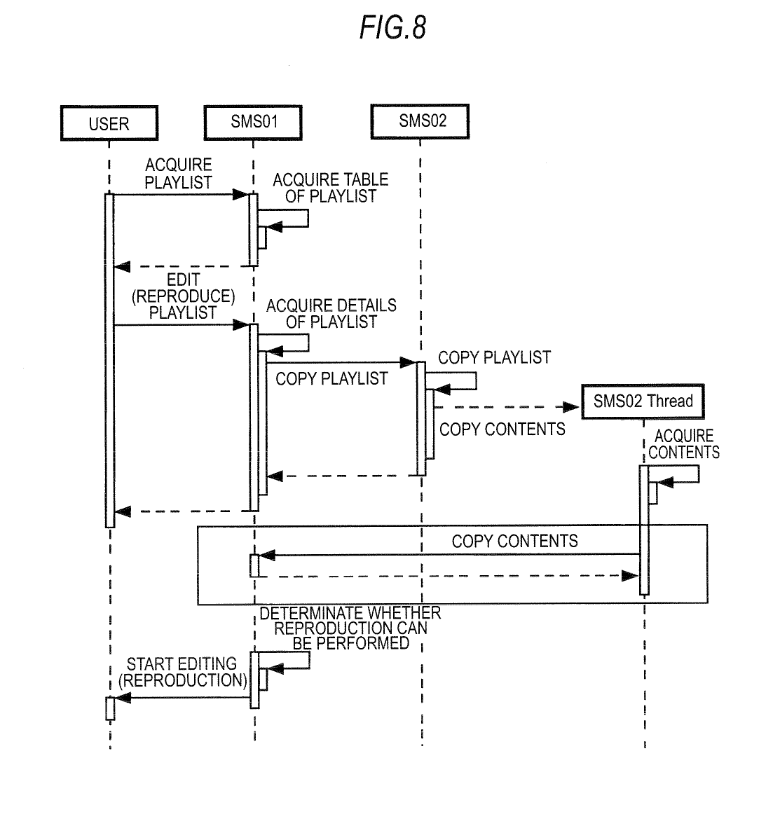

FIG. 4 is a schematic diagram indicating the sharing of contents/playlists in the content/playlist synchronization management unit. FIG. 5 is a view showing an example of a screen for sharing contents/playlists not having detailed information and FIG. 6 is a view showing an example of a screen for sharing contents/playlists indicated during acquisition of detailed information and FIG. 7 is a view showing an example of a screen for sharing contents/playlists obtained after the detailed information is acquired. FIG. 8 is a diagram showing an operation sequence of the content/playlist synchronization management unit.

The content/playlist synchronization management unit 122 in the screen management system comprehensively manages contents or playlists in the network. At this time, the user can access to the information of contents or playlists without being aware that the user refers to the information through the network. This is realized, for example, by storing the playlists 133 based on information acquired at the stage where the mutual-state monitoring unit 121 of the screen management system SMS01 monitors the mutual state as shown in FIG. 4.

In the content/playlist synchronization management unit 122, when instructed to perform reproduction/editing of a playlist/contents listed in the playlists 133, reproduction/editing of the playlist/contents is performed and the data is stored. Here, the playlist/contents the reproduction/editing of which has been instructed does not exist in the screen management system SMS01, the playlist/contents is acquired by being copied from the screen management system SMS02. Accordingly, the reproduction/editing of playlist/contents can be performed seamlessly and the data is stored. A specific example of content/playlist synchronization management will be shown below.

First, assume that the user logs in to the screen management system SMS01 and the screen management system SMS02 exists on the network. At this time, the mutual-state monitoring unit 121 of the screen management system SMS01 acquires the table of playlists from the screen management system SMS02 and stores the data in the storage unit 130.

Here, assume that the user instructs the screen management system SMS01 to access to the table of playlists. In response to this, the screen management system SMS01 acquires the playlists 133 in which the table of playlists is stored from the storage unit 130 and displays the playlists on a display unit of the screen management system SMS01.

The playlists 133 are displayed on the display unit of the screen management system SMS01, for example, with information acquired at the time of monitoring the mutual state as shown in FIG. 5. As the screen management system SMS01 has information of tables of playlists SPL1 and SPL2 and detailed information thereof as information in an example of screen display of the playlists 133, information of tables are shown in black letters. In relation to this, as detailed information of the playlists SPL3 and SPL4 has not been acquired through information of tables has been acquired from the screen management system SMS02, information of tables is displayed by a display manner different from black letters, for example, by gray letters for distinguishing the information on display.

Next, an operation of the content/playlist synchronization management unit 122 performed when the user intends to edit or reproduce the playlist SPL3 in the screen management system SMS02 will be explained.

When the user gives an instruction of editing or reproduction by designating the playlist SPL3, the screen management system SMS01 acquires the details of the playlists 133 as shown in FIG. 8. As the entity of the playlist SPL3 does not exist in the playlists 133 though the table of the playlist SPL3 of the screen management system SMS02 exists, the screen management system SMS01 requests the screen management system SMS02 to copy the playlist. In response to this, the screen management system SMS02 creates a copy of the requested playlist and returns the copy to the screen management system SMS01. At this time, as the response is returned from the screen management system SMS02 once, the screen display of the screen management system SMS01 will be an inverted display, for example, as shown in FIG. 6. That is, the display of a portion of the playlist SPL3 in which editing or reproduction has been instructed is changed to the display distinguished from information of other tables to thereby indicate that the playlist SPL3 is during the copy.

Here, in the case where the instruction in the screen management system SMS01 is editing of the playlist SPL3, the copy to the screen management system SMS01 is completed in a short period of time as the playlist itself is a file with a small amount of data. When the copy of the playlist is completed, the content/playlist synchronization management unit 122 changes the screen display shown during the copy to the normal black display as shown in FIG. 7. In response to this, the user can edit the playlist SPL3.

On the other hand, in the case where the instruction in the screen management system SMS01 is reproduction of the playlist SPL3, the entity of contents included in the playlist SPL3 is also necessary. As contents are a file with a large amount of data, the screen management system SMS02 creates a worker thread (SMS02 Thread) performing task processing in the background. The created worker thread acquires the contents included in the playlist SPL3 and sequentially copies the contents to the screen management system SMS01 in the background.

The content/playlist synchronization management unit 122 of the screen management system SMS01 determines whether the reproduction can be performed or not when the copy of the contents is completed and the data is stored in the contents 131 of the storage unit 130. In the case where all the contents included in the copied playlist SPL3 can be reproduced, the content/playlist synchronization management unit 122 changes the screen display shown during the copy to the normal black display as shown in FIG. 7. In response to this, the user can edit the playlist SPL3 and can reproduce the contents.

As described above, the screen management system SMS01 can share the contents and playlists in the entire movie theater by copying contents/playlists not included in the system itself from the screen management system having the contents/playlists.

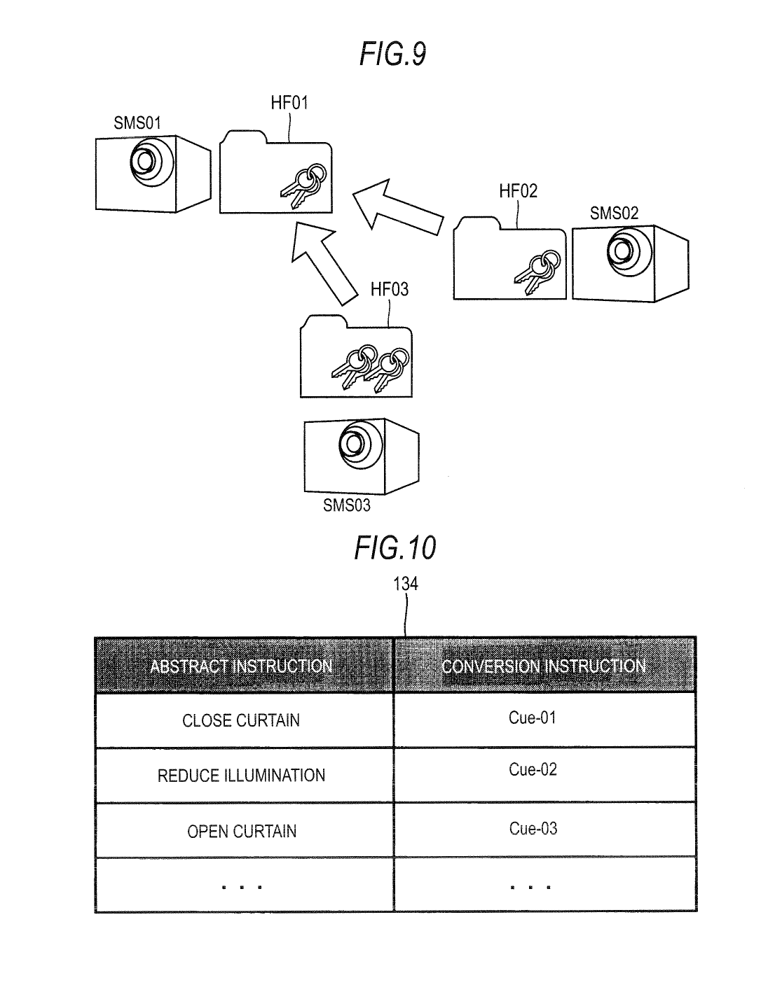

FIG. 9 is a diagram for explaining the sharing of keys in the key management unit.

Keys for screening movies (KDMs) to be necessary when videos are screened are generally stored in a temporary monitor folder called a hot folder for managing keys set as the keys 132 in the storage unit 130. That is, the screen management systems SMS01, SMS02 and SMS03 include hot folders HF01, HF02 and HF03 respectively, in which KDMs for decrypting the encrypted contents are stored.

Respective hot folders HF01, HF02 and HF03 are synchronized with one another. For example, when the key management unit 123 in the screen management system SMS01 refers to the hot folder HF01 of the system itself, KDMs stored in the hot folders HF02 and HF03 of other screen management systems SMS02 and SMS03 are also displayed in a list. Here, when contents copied from other screen management systems SMS02 and SMS03 are reproduced, management of keys are performed so that KDMs of the contents are imported to the hot folder HF01 and the contents are reproduced by using the KDMs.

As described above, the key management unit 123 shares keys so as to refer to hot folders of KDMs and to import the KDMs from any screen management system in the network according to need.

The screen management system being logged acquires positions of hot folders from other screen management systems on the network and mounts the hot folders just under the hot folder of the system itself. Then, when the contents are reproduced, keys can be shared with contents copied from other screen management systems by patrolling and searching the hot folder of the system itself.

Exchange of information of KDMs among the screen management systems on the network is performed when monitoring mutual states performed by the mutual-state monitoring unit 121 at regular time intervals, and the import of KDMs is performed in the background in the same way as the copy of contents shown in FIG. 8. Accordingly, as the user does not move KDMs by storage media among screen management systems, management of keys can be performed seamlessly.

FIG. 10 is a chart showing a configuration example of an abstract instruction conversion table used by the automation management unit.

The automation management unit 124 performs management so that instructions of the playlist in which automation operations are defined are abstracted and the automation operations of the abstract instructions are embodied by using the abstract instruction conversion table 134. That is, there are a large variety of automation operations defined by the playlist which are, for example, control of illumination in the movie theater, control of opening and closing curtains, control of changing audio setting and so on. Though such automation operations are performed in common in respective movie theaters, the setting of control instructions thereof is peculiar to respective movie theaters. For example, different types of machines are used in respective movie theaters in many cases concerning an audio processor, therefore, operation instructions for setting naturally differs from one another. The control of automation in movie theaters is supposed to be performed by the theater management system in large-scale movie theaters.

Accordingly, in the screen management system according to the embodiment of the present disclosure, the above automation management function is allowed to be included in the screen management system. In this case, as instructions of automation operations differ according to movie theaters, and further, according to screens, it is necessary to uniformly manage these instructions.

That is, in the screen management system according to the embodiment of the present disclosure, all automation instructions are abstracted in advance, and the abstract instruction conversion table 134 in which the abstracted abstract instructions and actual instructions corresponding to the abstract instructions are defined is prepared. The abstract instruction conversion table 134 is a correspondence table including abstract instructions and conversion instructions as shown in FIG. 10, and the link between abstract instructions and actual instructions is performed in each screen management system of the movie theater. The abstract instruction conversion table 134 is not changed unless equipment or setting of the movie theater is changed.

The automation management unit 124 converts abstract instructions defined in the playlist into actual instructions by using the abstract instruction conversion table 134 and transmits the instructions to a target to be controlled when the playlist in which automation operations are defined is reproduced.

As described above, as the automation management function is allowed to be included in the screen management system and the instructions are abstracted at the same time, it is possible to reduce modification points by modifying conversion instructions in conjunction with the change of a connecting device even when the connecting device is changed. At the time of modification, instructions are modified so as to correspond to abstract instructions, not directly modifying actual instructions, therefore, discrepancy in instructions hardly occurs.

According to the above configuration in which the screen management system includes part of functions of the theater management system, when the user logs in to one screen management system, other screen management systems can be comprehensively managed. Accordingly, as comprehensive management can be realized even in the small-scale movie theater in which installation of the theater management system is not necessary, which may obtain effects of staff reduction and so on.

As contents, playlists and keys can be shared among plural screen management systems, the user can manage the entire system without being aware to which screen management system the user logs in. However, operations such as editing and reproduction can be executed only by the screen management system being logged, therefore, errors on operations can be reduced. Additionally, as editing and so on of playlists can be performed, costs for installing or for maintaining/operating a new server are not necessary, which may obtain an effect of cost reduction.

Moreover, the connection among screen management systems is performed in a peer-to-peer network. Accordingly, as the network configuration can be dynamically changed, installation/change of new facilities can be easily performed and simplification of operations can be realized.

Additionally, as contents or playlists can be seen so that the network is transparent to the user without being aware of the network, operations can be performed even when the operation skill of user is low, and the reduction of training costs at the time of installation can be expected.

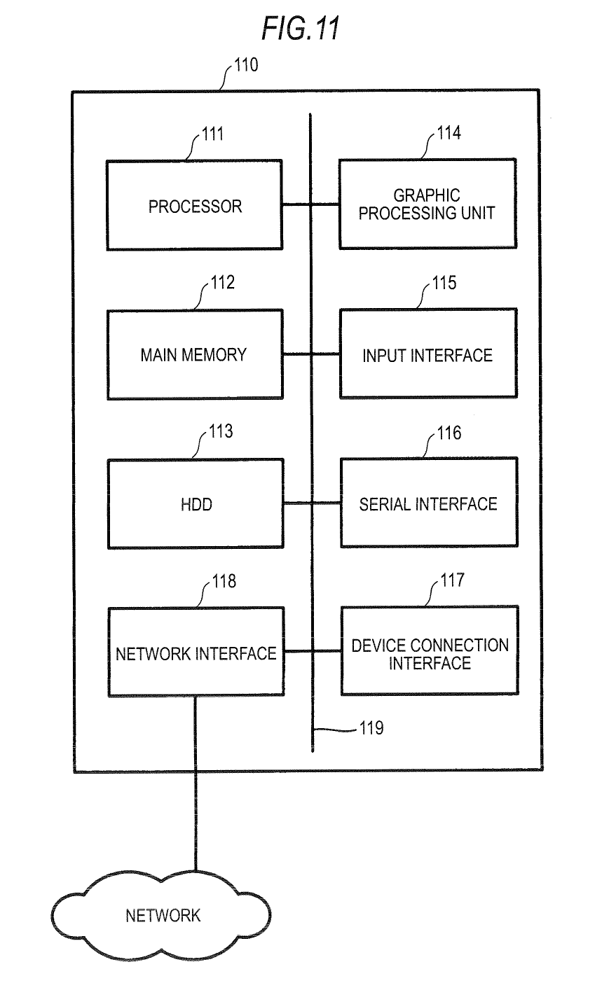

FIG. 11 is a diagram showing a configuration example of hardware of a media server.

The media server 110 is a computer which is entirely controlled by a processor 111. A main memory 112 and plural peripheral devices are connected to the processor 111 through a bus 119. The processor 111 is a CPU (Central Processing Unit) or a MPU (Micro Processing Unit).

In the main memory 112, at least part of programs of an OS (Operating System) and application programs to be executed by the processor 111 is temporarily stored. Various data necessary for processing by the processor 111 is also stored in the main memory 112.

As peripheral devices connected to the bus 119, there are an HDD (Hard Disk Drive) 113, a graphic processing unit 114, an input interface 115, a serial interface 116, a device connection interface 117 and a network interface 118.

The HDD 113 is used as an auxiliary storage unit magnetically performing writing and reading of data with respect to an internal disk, which forms the storage unit 130 of FIG. 1. The HDD 113 stores OS programs, application programs and various data. As the auxiliary storage unit, a semiconductor storage device such as a flash memory can be also used.

A display device is connected to the graphic processing unit 114, displaying images on a screen of the display device in accordance with an instruction from the processor 111. As the display device, a liquid crystal display device and so on can be used.

A keyboard, a mouse and so on are connected to the input interface 115. The input interface 115 transmits signals transmitted from the keyboard or the mouse to the processor 111.

The serial interface 116 is connected to the audio processor, an illumination control device, a curtain control device and so on. The serial interface 116 performs automation operations such as setting of the audio processor, control of illumination brightness, control of curtains for changing the size of the movie-showing screen in accordance with instructions from the processor 111.

The device connection interface 117 is a communication interface for connecting peripheral devices to the media server 110. For example, external storage devices such as the HDD and the semiconductor memory are connected to the device connection interface 117.

The network interface 118 is connected to the network. The network interface 118 performs transmission/reception of data with respect to the computer or other media servers 210 and 310 through the network.

Processing functions of the present embodiment can be realized by the above hardware configuration. Other media servers 210 and 310 can be realized by the same hardware as the media server 110.

The media server 110 realizes processing functions of the present embodiment by executing programs stored in recording media readable by the computer. Programs describing the processing contents executed by the media server 110 can be recorded in various recording media. For example, programs executed by the media server 110 can be stored in the HDD 113. The processor 111 loads at least part of the programs stored in the HDD 113 to the main memory 112 and executes the programs. The programs executed by the media server 110 can be recorded in portable recording media. The programs stored in the portable recording media can be executed after being installed in the HDD 113 by the control of the processor 111. It is also possible that the processor 111 directly reads programs from the portable recording media and executes the programs.

The embodiment of the present disclosure has been explained as the above. Modification examples of the embodiment will be explained.

### Modification Example 1

### Sharing of Setting of Screen Management Systems

In the function setting part of the screen management systems, the setting which is not peculiar to respective movie theaters, for example, the setting of the network and so on can be shared. Accordingly, when the projector system is newly installed in the movie theater, installation can be immediately performed without inputting complicated setting information by transferring a setting file, which may drastically cut the work time for performing the setting.

### Modification Example 2

### Control Among Screens

The screen management system to be a master can be sequentially changed by sequentially changing the screen management system to be logged, not being limited to a peculiar screen management system. Accordingly, it is possible to perform alive monitoring of systems to one another in a virtual manner among plural screen management systems, which can reduce human costs of the movie theaters.

### Modification Example 3

### Dynamic Reproduction of Contents on the Network

It is possible to reproduce contents/playlists held in other screen management systems while being downloaded to the screen management system being logged. Accordingly, it is possible to respond to sudden program change immediately.

### Modification Example 4

### Reservation of Redundancy of Contents on the Network

When contents are moved in the network, copies are generated in principle, therefore, plural storages hold the contents. Accordingly, if one of the contents is broken due to some kind of trouble, the content can be supplemented from other screen management systems, which leads to the redundancy of contents.

The present disclosure can also apply the following configuration.

(1) A movie-screening management device including

a mutual-state monitoring unit monitoring mutual states by periodically performing communication with other parties connected through a network to exchange information when being logged,

a content/playlist synchronization management unit sharing contents and playlists with the other parties, and

a key management unit comprehensively managing keys necessary for reproducing the contents with respect to the other parties.

(2) The movie-screening management device described in the above (1), further including

an automation management unit uniformly managing automation operations among the other parties, which include the setting of an audio processor, the control of brightness of illumination and the control of curtains for changing the size of a movie-showing screen which are set in respective screens.

(3) The movie-screening management device described in the above (1) or (2),

in which the connection with respect to the other parties is performed in a peer-to-peer network.

(4) The movie-screening management device described in any of the above (1) to (3),

in which the mutual-state monitoring unit transmits a command for checking network connectivity to the other parties to monitor states of the other parties by presence of a response with respect to the command.

(5) The movie-screening management device described in the above (2) or (4),

in which the mutual-state monitoring unit requests the other party to acquire information of a table of playlists and a table of contents possessed by the other party when the response of the transmitted command is returned.

(6) The movie-screening management device described in the above (5),

in which the mutual-state monitoring unit updates a database of the table of playlists and the table of contents when information of the table of playlists and the table of contents requested to the other party is acquired.

(7) The movie-screening management device described in the above (5),

in which the content/playlist synchronization management unit, when instructed to edit or reproduce a playlist in the acquired table of playlists, requests the other party having the designated playlist to acquire a copy of the playlist.

(8) The movie-screening management device described in the above (6),

in which the content/playlist synchronization management unit, when instructed to reproduce a playlist in the acquired table of playlists, acquires contents included in the playlist from the other party having the designated playlist in the background.

(9) The movie-screening management device described in the above (8),

in which the content/playlist synchronization management unit determines whether reproduction can be performed or not when all the contents have been acquired.

(10) The movie-screening management device described in the above (1) or (2),

in which the key management unit has a hot folder for sharing the keys, mounting the keys possessed by the other parties on the hot folder.

(11) A movie-screening management method including

acquiring information of a table of playlists and a table of contents possessed by other parties by periodically performing communication with other parties connected through a network when being logged,

when instructed to edit or reproduce a playlist in the acquired table of playlists, acquiring a copy of the playlist from the other party having the playlist, and

when instructed to reproduce a playlist in the acquired table of playlists, acquiring contents included in the playlist from the other party having the playlist in the background and reproducing the contents by using keys mounted on a hot folder.

The present disclosure contains subject matter related to that disclosed in Japanese Priority Patent Application JP 2012-121447 filed in the Japan Patent Office on May 29, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A movie-screening management device comprising:
a mutual-state monitoring unit monitoring mutual states by periodically performing communication with other parties connected through a network to exchange information when being logged;
a content/playlist synchronization management unit sharing contents and playlists with the other parties; and
a key management unit comprehensively managing keys necessary for reproducing the contents with respect to the other parties.

2. The movie-screening management device according to claim 1, further comprising:
an automation management unit uniformly managing automation operations among the other parties, which include the setting of an audio processor, the control of brightness of illumination and the control of curtains for changing the size of a movie-showing screen which are set in respective screens.

3. The movie-screening management device according to claim 1,
wherein the connection with respect to the other parties is performed in a peer-to-peer network.

4. The movie-screening management device according to claim 1,
wherein the mutual-state monitoring unit transmits a command for checking network connectivity to the other parties to monitor states of the other parties by presence of a response with respect to the command.

5. The movie-screening management device according to claim 1,
wherein the mutual-state monitoring unit requests the other party to acquire information of a table of playlists and a table of contents possessed by the other party when the response of the transmitted command is returned.

6. The movie-screening management device according to claim 5,
wherein the mutual-state monitoring unit updates a database of the table of playlists and the table of contents when information of the table of playlists and the table of contents requested to the other party is acquired.

7. The movie-screening management device according to claim 5,
wherein the content/playlist synchronization management unit, when instructed to edit or reproduce a playlist in the acquired table of playlists, requests the other party having the designated playlist to acquire a copy of the playlist.

8. The movie-screening management device according to claim 6,
wherein the content/playlist synchronization management unit, when instructed to reproduce a playlist in the acquired table of playlists, acquires contents included in the playlist from the other party having the designated playlist in the background.

9. The movie-screening management device according to claim 8,
wherein the content/playlist synchronization management unit determines whether reproduction can be performed or not when all the contents have been acquired.

10. The movie-screening management device according to claim 1,
wherein the key management unit has a hot folder for sharing the keys, mounting the keys possessed by the other parties on the hot folder.

11. A movie-screening management method comprising:
acquiring information of a table of playlists and a table of contents possessed by other parties by periodically performing communication with other parties connected through a network when being logged;
when instructed to edit or reproduce a playlist in the acquired table of playlists, acquiring a copy of the playlist from the other party having the playlist; and
when instructed to reproduce a playlist in the acquired table of playlists, acquiring contents included in the playlist from the other party having the playlist in the background and reproducing the contents by using keys mounted on a hot folder.
